(19) United States
(12) Patent Application Publication
(10) Pub. No.: US 2026/0141144 A1
(43) Pub. Date: May 21, 2026

(54) SHAPING A NETWORK-ON-CHIP TOPOLOGY PRIOR TO AUTOMATED TOPOLOGY SYNTHESIS

(71) Applicant: ARTERIS, INC., Campbell, CA (US)

(72) Inventor: Amir CHARIF, Paris (FR)

(73) Assignee: ARTERIS, INC., Campbell, CA (US)

(21) Appl. No.: 19/392,100

(22) Filed: Nov. 17, 2025

Related U.S. Application Data
(60) Provisional application No. 63/721,425, filed on Nov. 15, 2024.

(51) Int. Cl. G06F 30/327; G06N 3/0475; G06F 115/02

(52) U.S. Cl. CPC G06F 30/327; G06N 3/0475; G06F 2115/02

(57) ABSTRACT

A computer-implemented method of generating a network-on-chip (NoC) topology for an electronic system includes creating a logical description of a plurality of empty sub-networks that connect initiators to targets of an electronic system. The method further includes placing the sub-networks within free space of a floorplan of the electronic system in a desired topology shape; and performing automated topology synthesis to add switches to each of the sub-networks such that the initiators are connected to the targets in accordance with a communication policy.

### CROSS REFERENCE TO RELATED APPLICATION

This application claims benefit to US Provisional Application Serial No. 63/721,425 filed on November 15, 2024 and titled SYSTEM AND METHOD FOR NETWORK ON CHIP (NOC) USING AUTOMATION DESIGN TOOL by Amir Charif et al., the entire disclosure of which is incorporated herein by reference.

### FIELD

The present technology is in the field of electronic computer-aided design of electronic systems and, more specifically, related to topology generation for a network-on-chip (NoC).

### BACKGROUND

A system on chip (SoC) may include initiators, targets, and a NoC for handling communications between the initiators and the targets. A NoC is superior to point-to-point connectivity by way of a more scalable communication architecture that makes use of packet transmissions. It can support an ever-increasing number of cores on a single chip and a demand for ever-increasing processing power related to artificial intelligence (AI) and other applications.

During design of an SoC, an SoC architect designs a specification that includes a floorplan, power strategy, and constraints related to the SoC’s environment. The floorplan defines areas on the SoC for major functional blocks, including initiators and targets, and it defines an area that will be used for a NoC. The specification also defines NoC constraints.

During design of a NoC, a NoC topology is generated. A NoC topology refers to a general layout of NoC elements (e.g., network interface units, buffers, switches, firewalls, and adapters) and electrical connections between the NoC elements.

Automated topology synthesis is very effective at generating an initial NoC topology based solely on user-provided input constraints. In many instance, however, NoC designers want to have control over at least some parts of the NoC topology to produce a desired shape and/or switch organization. Such control is difficult to translate into the input constraints.

### SUMMARY

In accordance with various embodiments and aspects herein, a computer-implemented method of generating a NoC topology for an electronic system includes creating a logical description of a plurality of empty sub-networks that connect initiators to targets of the electronic system. The method further includes placing the sub-networks within free space of a floorplan of the electronic system in a desired topology shape; and performing automated topology synthesis to add switches to each of the sub-networks such that the initiators are connected to the targets in accordance with a communication policy.

In accordance with various embodiments and aspects herein, a product includes non-transitory computer readable medium storing a NoC design tool that, when executed, performs a method that includes loading a floorplan of an electronic system including a plurality of initiators and targets, the floorplan defining free space for a NoC; creating a logical topology of a plurality of empty sub-networks that connect the initiators to the sources; placing the sub-networks within free space of a floorplan of the electronic system in a desired topology shape; and performing automated topology synthesis to add switches to each of the sub-networks to connect the initiators to the targets.

In accordance with various embodiments and aspects herein, a computing system includes a processing unit; and computer-readable memory encoded with a NoC design tool. When executed, the NoC design tool causes the processing unit to create a logical topology of network-on-chip for an electronic system. The logical topology includes a plurality of empty sub-networks that connect initiators to targets in the electronic system. When executed, the NoC design tool further causes the processing unit to place the sub-networks within free space of a floorplan of the electronic system in a desired topology shape; and perform automated topology synthesis to add switches to each of the sub-networks such that the initiators are connected to the targets in accordance with a communication policy.

### BRIEF DESCRIPTION OF THE DRAWINGS

In order to understand the invention more fully, a reference is made to the accompanying drawings. The invention is described in accordance with the aspects and embodiments in the following description with reference to the drawings or figures(FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows an example of an electronic system including a NoC.

FIG. 2 shows a method of generating a hardware description of a NoC in accordance with various aspects and embodiments herein.

FIG. 3 shows an example of a connectivity table for a plurality of initiators and targets of an electronic system.

FIG. 4 shows a method of generating a NoC topology in accordance with various aspects and embodiments herein.

FIG. 5 shows an example of a logical topology in accordance with various aspects and embodiments herein.

FIG. 6 shows an example of a NoC topology in which some empty sub-networks have been placed in free space of a floorplan in accordance with various aspects and embodiments herein.

FIG. 7 shows an example of a NoC topology after topology synthesis of the sub-networks in accordance with various aspects and embodiments herein.

FIG. 8 shows a computing system including computer-readable memory that stores a NoC design tool in accordance with various aspects and embodiments herein.

FIG. 9 shows a computing system including computer-readable memory that stores a NoC design tool in accordance with various aspects and embodiments herein.

### DETAILED DESCRIPTION

The following describes various examples of the present technology. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment.

Thus, appearances of the phrases “in one embodiment,” “in at least one embodiment,” “in an embodiment,” "in certain embodiments," and similar language throughout this specification may, but do not necessarily, all refer to the same embodiment or similar embodiments. Furthermore, aspects and embodiments described herein are merely exemplary, and should not be construed as limiting of the scope or spirit of the invention as appreciated by those of ordinary skill in the art. All statements herein reciting principles, aspects, and embodiments are intended to encompass both structural and functional equivalents thereof. It is intended that such equivalents include both currently known equivalents and equivalents developed in the future. Furthermore, to the extent that the terms "including", "includes”, “having", "has", "with", or variants thereof are used in either the detailed description and the claims, such terms are intended to be inclusive in a similar manner to the term "comprising."

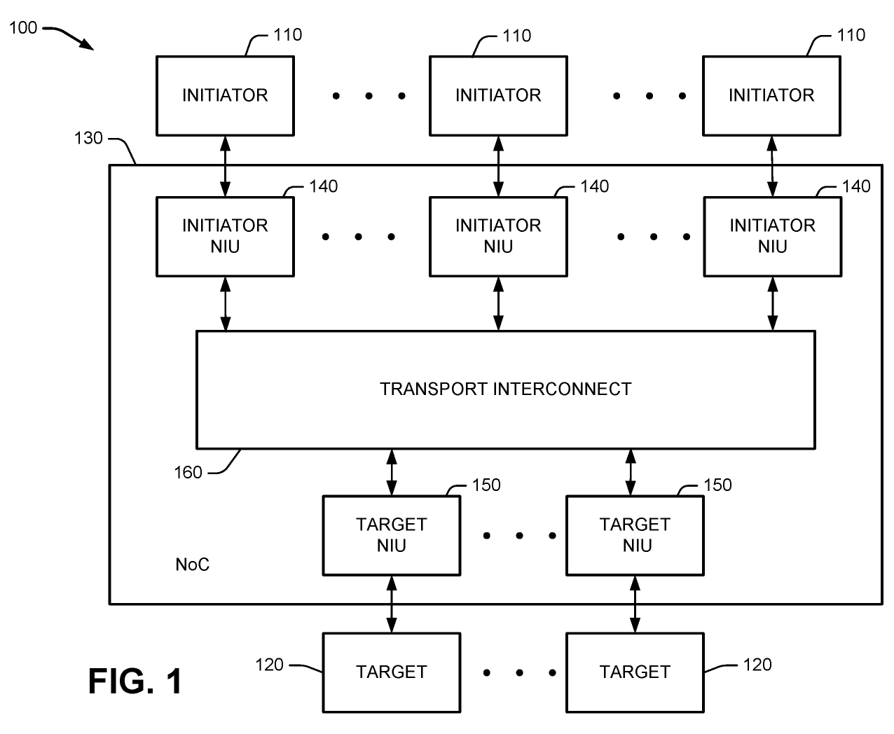

Reference is made to FIG. 1, which illustrates a simple example of an SoC 100 including a plurality of initiators 110 and targets 120. Examples of the initiators 110 include central processing units (CPUs), graphics processing units (GPUs), video cards, accelerators, and direct memory access (DMA) controllers. Examples of the targets 120 include volatile memory, persistent memory, and peripherals.

The SoC 100 further includes a NoC 130. The NoC 130 sends request transactions from an initiator 110 to one or more targets 120. For example, the NoC 130 receives a request transaction from an initiator 110, decodes an address in the request transaction, and transports the request transaction to the target 120, which handles the request transaction. The target 120 may respond with a response transaction, which is transported back to the initiator 110 via the NoC 130.

The NoC 130 includes a plurality of network interface units (NIUs) 140 and 150 and a transport interconnect 160. Each initiator 110 is coupled to the transport interconnect 160 via a corresponding initiator NIU 140. Each target 120 is coupled to the transport interconnect 160 via a corresponding target NIU 150.

Each initiator NIU 140 is configured to convert the protocol used by its corresponding initiator 110 into a transport protocol that is used inside the NoC 130. Each target NIU 150 is configured to convert the transport protocol used inside the NoC 130 into a protocol that is used by its corresponding target 120. The transport protocol is typically based on the transmission of packets.

The transport interconnect 160 transports packets between the initiator NIUs 140 and the target NIUs 150. The transport interconnect 160 includes switches, adapters, and buffers. Switches may be used to route flows of traffic between sources and destinations. Adapters may be used to deal with various conversions between data width, clock domains, and power domains. Buffers may be used to insert pipelining elements to span long distances, or to store packets to deal with rate adaptation between fast senders and slow receivers or vice-versa.

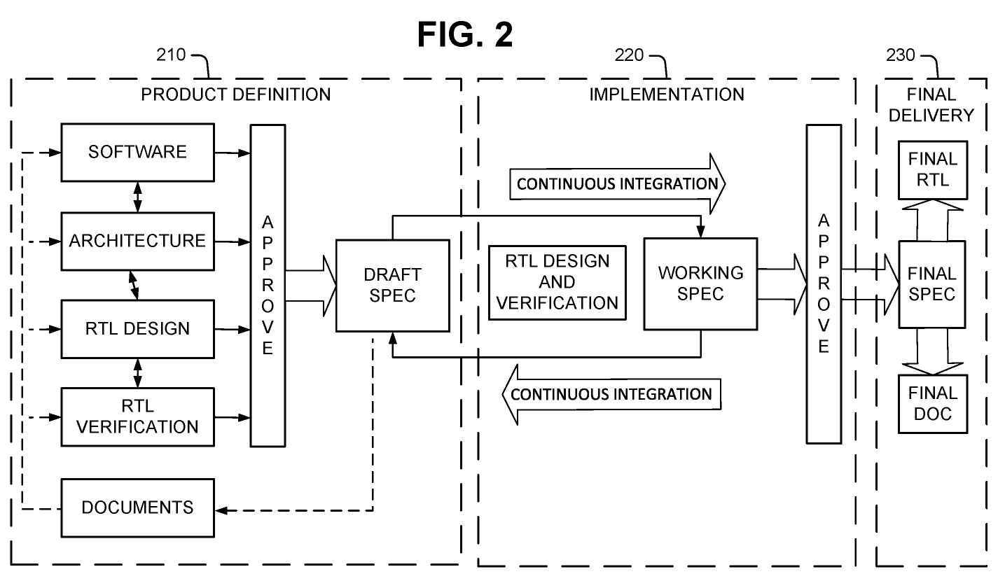

FIG. 2 shows an example of a method of generating a hardware description of a NoC. At block 210, a product is defined. An SoC architect designs a specification that includes a floorplan for an SoC, power strategy, and constraints related to the SoC’s environment (e.g., clocks and their frequencies, quality of service, and type of protocol used with macros). The specification also describes a communication policy, which may include a connectivity table that specifies NoC connectivity for different traffic classes.

Among other things, the floorplan defines areas on the chip for major functional blocks of the chip, including initiators and targets. The floorplan also defines blockages, and it also defines the area that will be used for a NoC (that is, the “free space” for the NoC). The specification may place additional constraints on the NoC. Examples of additional constraints include frequency, routing congestion, and power consumption.

A NoC topology is generated to fit within the free space defined by the floorplan. An initial topology is generated according to a method herein. A method herein includes automated topology synthesis, but allows a NoC designer to have control over at least some parts of the NoC topology.

A hardware description of the NoC design is generated. Register Transfer Level (RTL) may be used for design and verification flow. In addition, software is developed. An RTL description may then be delivered to an SoC integrator in the form of a draft specification.

At block 220, a product definition is implemented. The SoC integrator performs integration, synthesis, and simulations to determine whether the NoC design in the RTL description fits into the free space defined by the floorplan, exhibits predictable results about operation frequency, and satisfies other constraints such as routing congestion, and power consumption. The integration is continuous until a working specification has been approved.

At block 230, a final specification is delivered. The final specification may include a final RTL description and documentation.

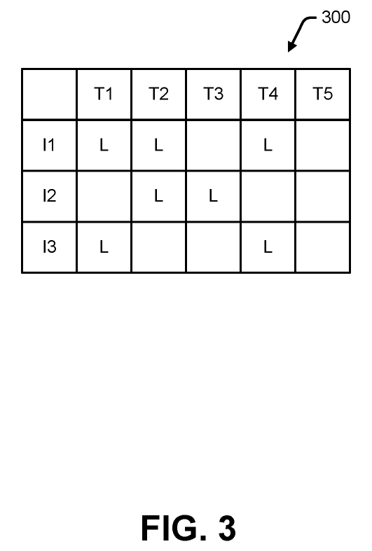

FIG. 3 shows a simple example of a connectivity table 300 that specifies NoC connectivity. Each initiator I1, I2, and I3 is assigned a row, and each target T1, T2, T3, T4 and T5 is assigned a column. If a given initiator is specified to send traffic to a given target, an “L” is presented at the intersection of the given initiator row and the given target column. If no label is present at the intersection, then there is no connectivity between that given initiator and that given target. For example, initiator I1 connectively communicates with targets T1, T2 and T4. 1. However, initiator I1 does not communicate with targets T3 and T5.

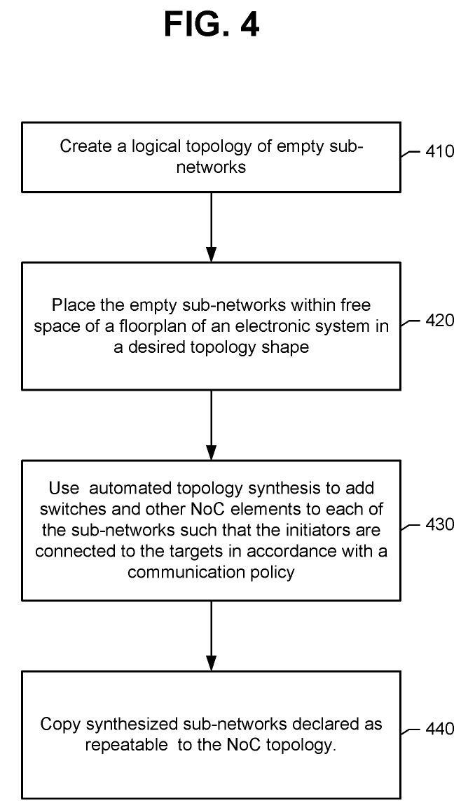

Reference is made to FIG. 4, which shows a computer-implemented method of generating a NoC topology for an electronic system that includes a plurality of initiators and targets. At block 410, a logical topology of empty sub-networks that connect the initiators to the targets is created. As used herein, an empty sub-network refers to a sub-network that does not contain any NoC elements. The logical topology describes a high-level sub-network architecture of a NoC.

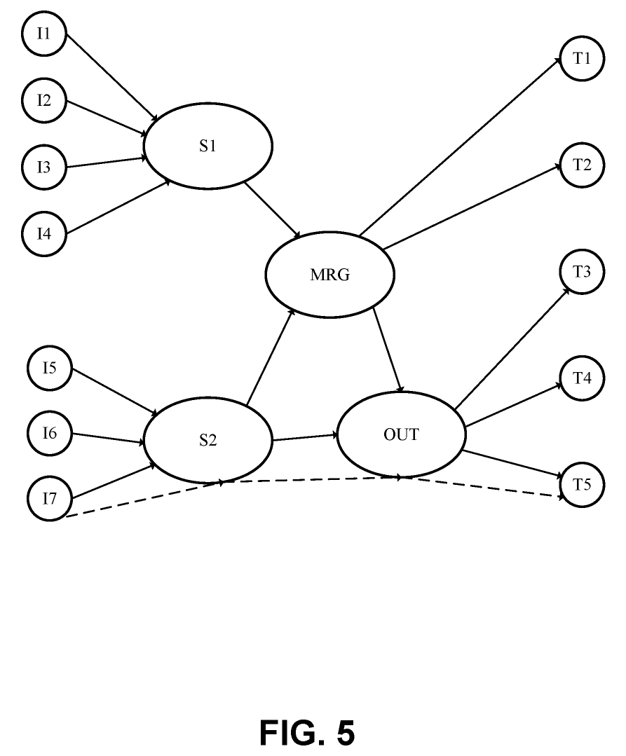

FIG. 5 shows an example of a graphics-based version of a logical topology. In this example, a NoC designer desires initiators I1, I2, I3 and I4 to go through a first sub-network S1, and initiators I5, I6 and I7 to go through a second sub-network S2. The NoC designer further desires outputs of the first and second sub-networks S1 and S2 to merge at a third sub-network merge (MRG), and outputs of the third sub-network MRG to go to targets T1 and T2. The NoC designer further desires another output of the second sub-network S2 and another output of the third sub-network MRG to go to a fourth sub-network OUT. Finally, the NoC designer desires outputs of the fourth sub-network OUT go to targets T3, T4 and T5.

A text-based version of the logical topology of FIG. 5 of may be as follows. The text-based version is designed to be compact and easy to digest in embodiments that use a machine learning model as described below.

frag (I1 I2 I3 I4) s1 mrg

frag (I5 I6 I7) s2 mrg

frag s1 mrg (T1 T2)

frag s2 mrg out

frag (s2 mrg) out (T3 T4 T5)

route I7 s2 T5

The declaration “frag” represents a fragment, where a fragment is described as a succession of two or more sub-networks. The parentheses compactly represent the same declaration to multiple initiators or targets.

The declaration “route” represents a hard-coded route. Thus, route I7 s2 T5 represents that a route from initiator I7 to target T5 is hard-coded.

The logical topology may be created before or after a floorplan of the electronic system has been created. In some embodiments, the logical description is created by a NoC designer using a NoC design tool.

Reference is once again made to FIG. 4. At block 420, the empty sub-networks are placed within free space of a floorplan of the electronic system in a desired topology shape. In some embodiments, placement of the sub-networks may attempt to minimize metrics such as wire length, route deviation and latency.

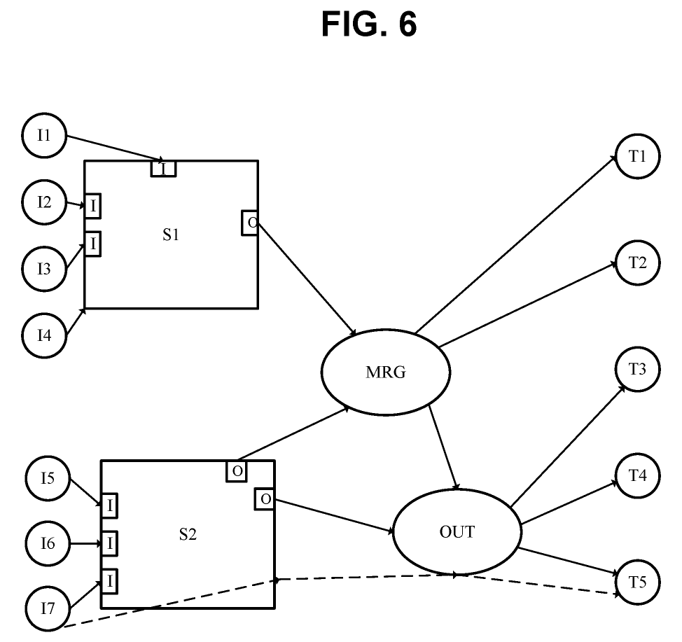

Reference is made to FIG. 6, which illustrates placement of the empty sub-networks. To reduce clutter in FIG. 6, boundaries of only the sub-networks S1 and S2 are shown. These boundaries are represented by boxes. Each sub-network has input and output ports. In FIG. 6, the input ports are labeled “I” and the output ports are labeled “O.”

A text-based description of the logical topology of FIG. 6 may be as follows.

frag (I1 I2 I3 I4) s1 mrg

frag (I5 I6 I7) $s2([I1 I2 I3], o2) mrg

frag s1 mrg (T1 T2)

frag s2 mrg out

frag $s2(, o2) mrg) out

frag ($s2 (, o1) mrg) out (T3 T4 T5)

route I7 $s2(i3, o1) T5

where $S2 represents an expanded logical description of the second sub-network to include the input and output ports.

Reference is once again made to FIG. 4. At block 430, automated topology synthesis is used to add switches and other NoC elements to each of the sub-networks such that the initiators are connected to the targets in accordance with a communication policy. A sub-network may be a simple as a single switch, or it may have a complex topology. The automated topology synthesis may or may not be physically-aware. The automated topology synthesis produces synthesized sub-networks.

An example of automated topology synthesis is disclosed in Applicant/Assignee’s U.S. Serial No. 19/095,082 filed 31 March 2025 and titled “INCREMENTAL TOPOLOGY SYNTHESIS FOR A NETWORK-ON-CHIP,” the entire disclosure of which is incorporated herein by reference. In general, a source is selected, and multiple destinations to which the source will be connected are identified. New connections are incrementally added to the NoC topology, one connection at a time. Adding a new connection includes selecting a next destination, and adding to the topology a new valid shortest distance connection from the next destination to an existing connection in the topology.

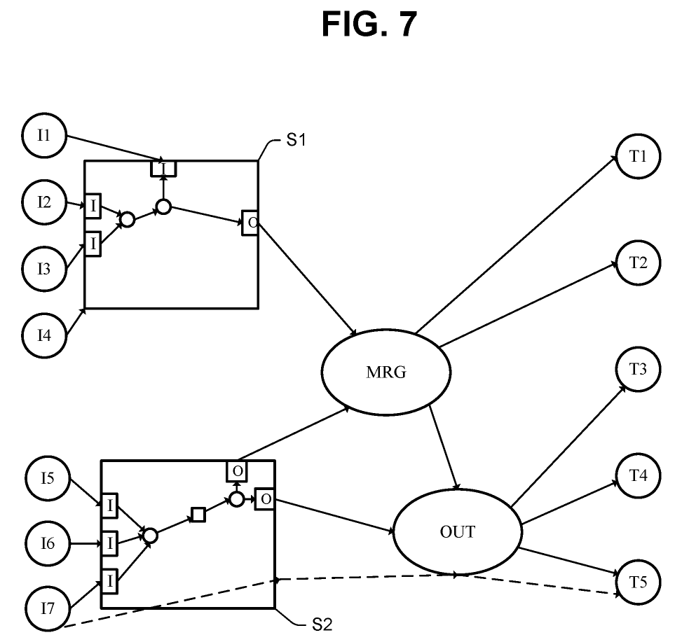

Additional reference is made to FIG. 7, which shows switches added to each of the sub-networks S1 and S2 by automated topology synthesis. Although not shown, automated topology synthesis may be used to add switches and other NoC elements to the third sub-network MRG and the fourth sub-network OUT.

At block 440, synthesized sub-networks declared as repeatable may be copied and added to the NoC topology. Repeatable sub-networks may have, for example, the same number of inputs and outputs, the same connectivity requirements, similar sub-network boundary placements, etc.

If it is desired to make the second sub-network S2 repeatable, the second sub-network S2 may be declared as follows.

Sub_net three_to_two

in i1 i2 i3

out 0102

frag (i1 i2 i3) s !l s’ (o1 o2)

end

An instance of the repeatable sub-network may be can be created as follows. inst three_to_two s2

The method of FIG. 4 allows a NoC designer to plan a NoC topology at a high level. This high-level planning becomes especially valuable for NoC topologies having hundreds of switches. Further, the method of FIG. 4 enables a NoC designer to use automated topology synthesis based solely on user-provided input constraints, yet still have control over at least some parts of the topology to produce a desired shape and/or switch organization.

Additional advantages may be obtained by declaring certain sub-networks as repeatable. Even if a repeatable sub-network is described at a higher level, the automated NoC topology synthesis is performed only once, and a synthesized repeatable sub-network is copied to multiple locations in the free space. Processing burden and development time are reduced, and computational resources are preserved. This is especially advantageous for neural network chips and other electronic systems where operations that are essentially the same are repeated many times.

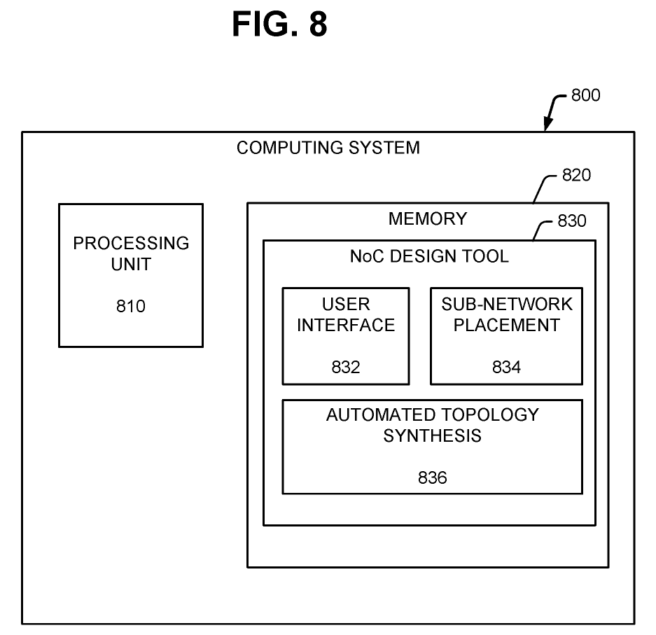

Reference is now made to FIG. 8, which illustrates a computing system 800 including a processing unit 810, and machine-readable memory 820 that stores a NoC design tool 830. The NoC design tool 830 may include a user interface 832 for allowing a NoC designer to create a logical topology including empty sub-networks and optionally place the empty sub-networks in free space of a floorplan. The NoC design tool 830 may further include code 834 that, when executed by the processing unit 810, places the empty sub-networks in free space of a floorplan, while minimizing wire length and other metrics associated with the placement. The NoC design tool 830 may further include code 836 that, when executed by the processing unit 810, performs automated topology synthesis on each sub-network.

Some embodiments of a computing system herein may leverage a large learning model (LLM) or other generative artificial intelligence (AI) model that performs code generation. See, for example, Applicant/Assignee PCT Application Serial No. PCT/US25/55441 filed November 13, 2025 and titled NATURAL LANGUAGE EDITING OF A NETWORK=ON-CHIP DESIGN, which is incorporated herein by reference. In some embodiments, PCT/US25/55441 describes a computing system including a NoC design tool configured with an application programming interface (API) having functions for NoC design editing. The computing system further includes an agent configured to generate and send prompts to a generative AI model that performs code generation. The prompts include a description of a NoC design, a description of how to use the API, a user input specifying one or more natural language modifications to the NoC design, and a request for the generative AI model to generate a script that uses the API to edit the NoC design as specified in the user input. The agent is further configured to forward the script to the NoC design tool. The NoC design tool is configured to execute the script to modify the NoC design. Thus, a NoC designer can enter natural language instructions into the NoC design tool to create and modify a NoC design.

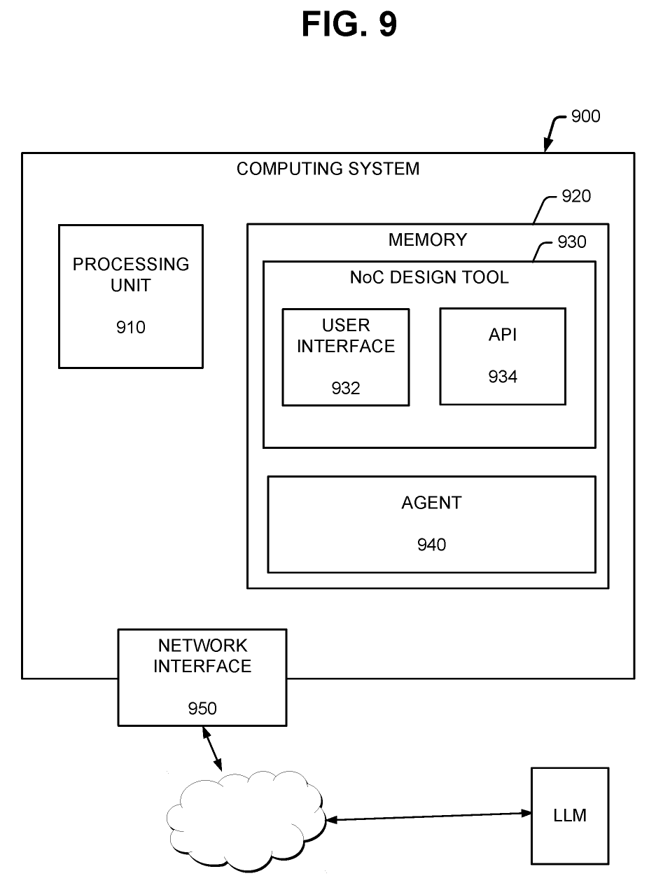

Reference is made to FIG. 9, which shows a computing system 900 based on the computing system of PCT Application Serial No. PCT/US25/55441. The computing system 900 of FIG. 9 includes a processing unit 910, and computer-readable memory 920 encoded with a NoC design tool 930. The NoC design tool 930 of FIG. 9 includes a user interface 932 that enables a NoC designer to create a logical topology and add sub-networks of the logical topology to free space of a floorplan. The user interface 932 is further configured to accept natural language instructions from a NoC designer or other user.

The NoC design tool 930 of FIG. 9 also includes an application programming interface (API) 934. The API 934 includes editing functions that programmatically create, configure and modify NoC elements of a NoC design. Higher-level editing functions can perform automations such as placement and routing, and automated NoC topology synthesis. The placement and routing functions can be performed on NoC elements, and they can also be performed on sub-networks. The automated NoC topology synthesis functions can be applied to the entire free space of a floorplan, and it can also be applied to sub-networks.

The computer-readable memory 920 is also encoded with an agent 940, which communicates with an LLM (or other AI generative model that can generate code) via a network interface 950. The agent 940 is configured to generate and send prompts to the LLM. The prompts include a floorplan showing free space for a NoC, the logical topology, a description of how to use the API 934, and a user input specifying one or more natural language instructions for the LLM to generate a script that uses the API 934 to add sub-networks to the free space, perform automated topology synthesis on the sub-networks, and use any sub-networks identified as repeatable. The agent 940 is further configured to receive a script from the LLM, and forward the script to the NoC design tool 930, which executes the script to generate a NoC topology in the free space. Advantageously, a NoC designer can create a logical topology and, with natural language commands, turn that logical topology into a fully synthesized NoC topology.

Certain methods, which can be implemented in a product, according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, IP elements or units include: processors (e.g., CPUs or GPUs), random-access memory (RAM – e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms "including", "includes”, “having", "has", "with", or variants thereof are used in either the detailed description and the claims, such terms are intended to be inclusive in a similar manner to the term "comprising."

The scope of the invention, therefore, is not intended to be limited to the exemplary embodiments shown and described herein. Rather, the scope and spirit of present invention is embodied by the appended claims.

What is claimed is:

1. A computer-implemented method of generating a network-on-chip (NoC) topology for an electronic system including a plurality of initiators and a plurality of targets, the method comprising:
creating a logical topology of a plurality of empty sub-networks that connect the plurality of initiators to the plurality of targets;
placing the plurality of empty sub-networks within free space of a floorplan of the electronic system in a desired topology shape; and
performing automated topology synthesis to add switches to each of the plurality of empty sub-networks such that the plurality of initiators are connected to the plurality of targets in accordance with a communication policy.

2. The computer-implemented method of claim 1, wherein the logical topology is generated prior to accessing the floorplan.

3. The computer-implemented method of claim 1, wherein placing the plurality of empty sub-networks within the free space includes minimizing placement metrics.

4. The computer-implemented method of claim 1, wherein the automated topology synthesis includes incremental topology synthesis.

5. The computer-implemented method of claim 1, further comprising identifying a sub-network that is repeatable and adding copies of the repeatable sub-network to the free space.

6. The computer-implemented method of claim 1, further comprising requesting an artificial intelligence (AI) generative model to generate a script for placing the plurality of empty sub-networks within the free space.

7. The computer-implemented method of claim 6, wherein:
a NoC design tool is used for logical topology creation, sub-network placement, and automated topology synthesis,
the NoC design tool has an application programming interface (API) for programmatically performing a sub-network placement and topology synthesis, and
requesting includes sending a prompt to the AI generative model, the prompt including the floorplan, the logical topology, a description of how to use the API, and natural language instructions for the AI generative model to generate a script for placing sub-networks in the free space and for performing the automated topology synthesis on the sub-networks.

8. A product comprising non-transitory computer-readable medium storing a NoC design tool that, when executed, performs a method including:
loading a floorplan of an electronic system including a plurality of initiators and a plurality of targets, the floorplan defining free space for a network-on-chip (NoC);
creating a logical topology of a plurality of empty sub-networks that connect the plurality of initiators to the plurality of targets;
placing the plurality of empty sub-networks within free space of a floorplan of the electronic system in a desired topology shape; and
performing automated topology synthesis to add switches to each of the plurality of empty sub-networks to connect the plurality of initiators to the plurality of targets.

9. The product of claim 8, wherein placing the plurality of empty sub-networks within the free space includes minimizing placement metrics.

10. The product of claim 8, wherein the automated topology synthesis includes incremental topology synthesis.

11. The product of claim 8, wherein the method performed by the NoC design tool further includes identifying a sub-network that is repeatable; and adding copies of synthesized, repeatable sub-networks to the free space.

12. The product of claim 8, further comprising an agent stored in the non-transitory computer-readable medium; wherein the agent, when executed, issues requests to an artificial intelligence (AI) generative model to generate a script for placing sub-networks within the free space.

13. The product of claim 12, wherein:
the NoC design tool has an application programming interface (API) for programmatically performing sub-network placement and topology synthesis; and
the requests include prompts to the AI generative model, the prompts including the floorplan, the logical topology, a description of how to use the API, and natural language instructions for the AI generative model to generate a script for placing sub-networks in the free space and for performing the automated topology synthesis on sub-networks.

14. A computing system comprising a processing unit; and computer-readable memory encoded with a NoC design tool that, when executed, causes the processing unit to:
create a logical topology of network-on-chip for an electronic system, wherein the logical topology includes a plurality of empty sub-networks that connect initiators to targets in the electronic system;
place the plurality of empty sub-networks within free space of a floorplan of the electronic system in a desired topology shape; and
perform automated topology synthesis to add switches to each of the plurality of empty sub-networks such that the initiators are connected to the targets in accordance with a communication policy.

15. The computing system of claim 14, wherein placing the plurality of empty sub-networks within the free space includes minimizing placement metrics.

16. The computing system of claim 14, wherein the NoC design tool, when executed, further causes the processing unit to identify a sub-network that is repeatable; and add copies of synthesized, repeatable sub-networks to the free space.

17. The computing system of claim 14, wherein the computer-readable memory is further encoded with an agent that, when executed, causes the processing unit to request an artificial intelligence (AI) generative model to generate a script for placing sub-networks within the free space.

18. The computing system of claim 17, wherein:
the NoC design tool has an application programming interface (API) for programmatically performing sub-network placement and topology synthesis, and
the request performed by the agent includes sending a prompt to the AI generative model, the prompt including the floorplan, the logical topology, a description of how to use the API, and natural language instructions for the AI generative model to generate a script for placing sub-networks in the free space and for performing the automated topology synthesis on sub-networks.
